(19) United States
(12) Patent Application Publication
(10) Pub. No.: US 2010/0088690 A1
(43) Pub. Date: Apr. 8, 2010

(54) REPLACING THE IDENTITY OF AN ACTIVEX CONTROL

(75) Inventors: Yakir Levi, Tel Aviv (IL); Henit Ben Adi, Mevo-Dotan (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,545

(22) Filed: Oct. 3, 2008

(51) Int. Cl. G06F 9/44

(52) U.S. Cl. 717/168

(57) ABSTRACT

A development tool is provided that finds existing ActiveX identification resources in a binary module, generates new identification resources, and then outputs commands to a resource patching tool. Execution of the commands will cause the resource patching tool to patch the newly generated ActiveX identification resources into the binary module to replace the existing identification resources. This technique allows ActiveX controls to be separately registered and differentiated. ActiveX controls can thus be efficiently implemented with different branding, for example, and/or concurrently used without concern that the execution of one will be affect another.

### BACKGROUND

Binary modules such as EXE (executable), DLL (dynamic linked library) and OCX (object linking and embedding control extension) are commonly utilized to provide modularized functionality to a program or application that runs on a computing platform such as a PC (personal computer). Each binary module can be loaded into the main program at run time which can speed up load time since a module is typically loaded only when the functionality that it provides is needed.

In addition, updates are often easier to apply to each binary module without affecting other parts of the program. For example, a payroll and benefits program may need to deal with tax rates that change every year. When these changes are isolated into a binary module, the module can be updated without needing to build or install the whole program again. This feature thus saves development time and expense while simplifying deployment and installation of the program in the runtime environment.

Binary modules typically contain program code and resources of various kinds and languages such as strings, icons, bitmaps, dialog templates, and menus. Binary modules may use the same code but be compiled with different sets of resources in order to create modules that have different configurations. For example, a binary module that implements an agent named agent.exe can have different resources to implement different branding for the module. Then during runtime, the user will interact with interface elements such as splash screens, icons, strings, menus, etc., that are specific to the module's branding. Use of different resources thus enables the user experience to be customized to a given application without needing to change the program code. However, existing methods for creating the different variations or “flavors” of binary modules require distinct configurations of the module to be compiled with each having the same code but using different resources. These methods are inefficient by requiring developers to expend more time and effort to create the desired binary modules.

Binary modules can also utilize ActiveX controls to provide additional functionality as a plug-in to applications such as web browsers that utilize HTML (Hypertext Markup Language) code contained in web pages. An ActiveX is a COM (common object model) object that enables binary code to be readily invoked and also provides access to certain resources provided by the operating system. For example, ActiveX controls might be used by web pages to read certain file types, render media content using a player, or display animation.

ActiveX controls are registered in the registry by implementing, for example, DllRegisterServer and DllUnregisterServer functions under COM. A web page can then identify the ActiveX control using its registration data (which typically comprises registry keys and values) and the browser can load the control. Unfortunately, difficulties might arise if multiple web sites were to use the same binary module as the concurrent registrations of ActiveX controls could result in unexpected and undesirable program behavior as one program could affect another.

### SUMMARY

A resource patching tool is configured to enable resources from an external source module to be added or replaced in a binary module after the module is built as an executable program. A developer may use the resource patching tool to place different resources into a generic binary module to easily and efficiently create different branding without having to rebuild the module. Thus, for example, a single instance of agent.exe can be built that does not have any resources so that different resources cab be patched into it post-build using the resource patching tool to create different binary module configurations with the desired branding.

In various illustrative examples, the resource patching tool is implemented to be run using a command line interface on a computing platform such as a PC. Using command lines, a developer can add or replace resources from a source module into the destination binary module where the resource types may include icon, menu, string, and binary. Version resources (e.g., a file version or product version) can be replaced and also edited. Multi-language support is enabled so that, for example, an English language string can be replaced by a Japanese language string. And, resources can be patched into multiple destination binary modules simultaneously.

The functionality of the resource patching tool may be extended by a second development tool that finds the existing ActiveX identification resources in a binary module, generates new identification resources, and then outputs commands to the resource patching tool. Execution of the commands will cause the resource patching tool to patch the newly generated ActiveX identification resources into the binary module to replace the existing identification resources. This technique allows ActiveX controls to be separately registered and differentiated. ActiveX controls can thus be efficiently implemented with different branding, for example, and/or concurrently used without any concern that the execution of one will affect another.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows typical application development and usage environments in which a binary module is built to implement various interface elements when executing during runtime;

FIG. 2 shows an illustrative group of differently configured binary modules and associated resources that are typically utilized to provide programs with user experiences that have different branding;

FIG. 3 shows an illustrative generic binary module into which resources can be patched post-build using the resource patching tool;

FIG. 4 shows various illustrative capabilities of the resource patching tool;

FIG. 5 shows additional operative details of the resource patching tool which include the generation of a log;

FIG. 6 shows the interoperation of an ActiveX customization tool and the resource patching tool to enable ActiveX identification resources to be patched into a binary module such as a DLL or OCX; and

FIG. 7 is a flowchart of illustrative operations of the ActiveX customization tool.

Like reference numerals indicate like elements in the drawings.

### DETAILED DESCRIPTION

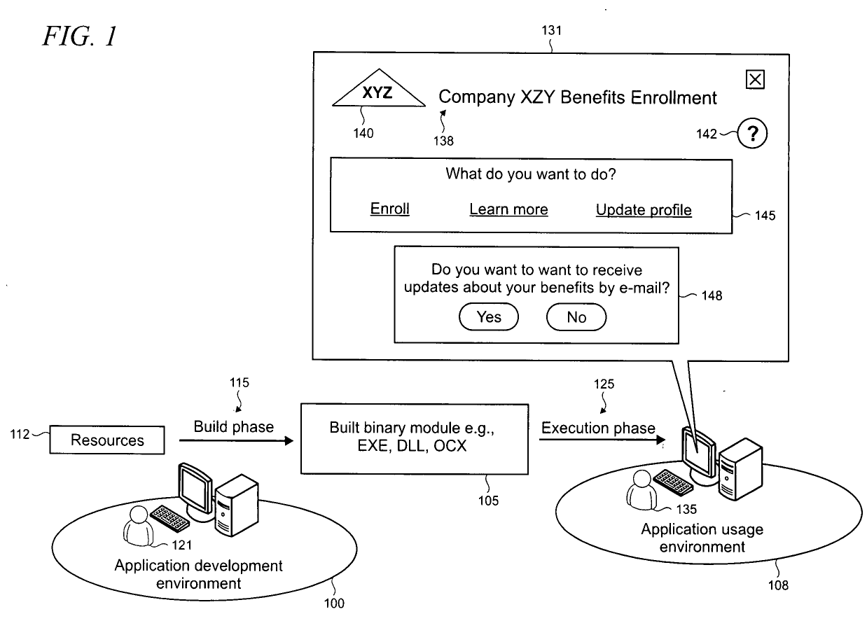

FIG. 1 shows a typical application development environment 100 that is used to build a binary module 105 that executes in a usage environment 108. The binary module 105, in this illustrative example, uses resources 112 that are included during a build phase of the module (as indicated by reference numeral 115) in the development environment 100. That is, a developer 121 will typically specify resources that get compiled with code into the binary module 105 to produce a desired programmed behavior during the module's execution phase (as indicated by reference numeral 125 in the usage environment 108. The binary module 105 can vary by type, but will often typically comprise an EXE, DLL, OCX, or other executable.

The particular resources 112 used can vary by implementation, but in this example include interface elements of various kinds such as strings, icons, bitmaps, dialog templates, and menus. The resources may also be constructed using different languages (e.g., English, French, Hebrew, Japanese, etc.). As shown in FIG. 1, the interface elements comprising the resources 112 can be used to implement a user experience such as graphical user interface (“GUI”) 131 that uses branding. The branding is implemented for a user 135 in the application usage environment 108 through the various interface elements that are created and displayed in the GUI 131 during the execution phase 125 of the binary module 105. These elements include strings 138, bitmaps 140, icons 142, menus 145, and dialog boxes 148. It is emphasized that the particular interface elements shown in this example are intended to be illustrative only and that other interface elements may be used in various combinations as may be required in a given implementation.

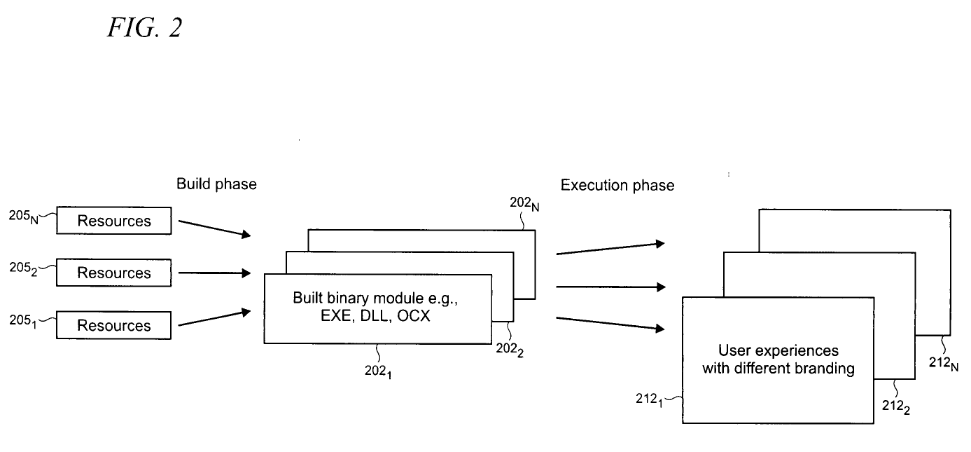

As shown in FIG. 2, in typical existing development environments, the developer will generally need to build multiple different binary modules 202_{1, 2 . . . N} in order to implement different branding configurations (i.e., “flavors”) for the user experience which may use different interface elements. Each binary module configuration will use different respective resources 205_{1, 2 . . . N} but will typically use the same program code. In this way, each GUI 212_{1, 2 . . . N} can have a different look and feel, use different languages, etc., when a binary module runs during the execution phase. However, providing the different configurations has a cost in development time and effort to build the multiple binary modules 202 and can thus be inefficient.

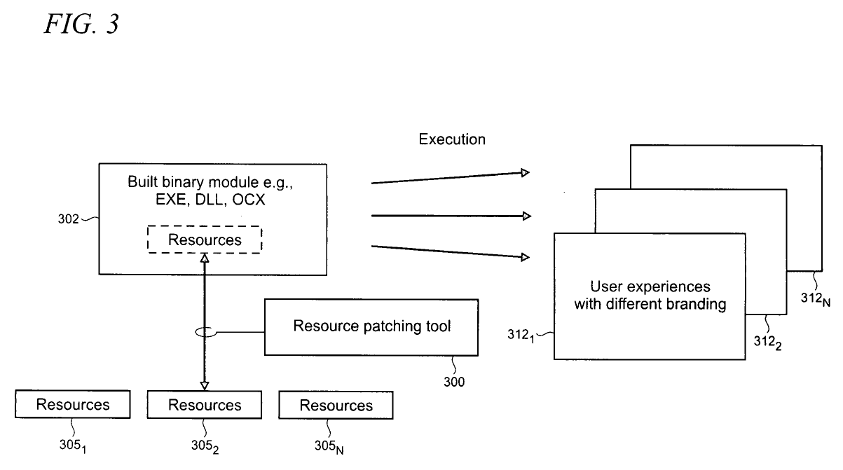

In comparison to current methods, the present resource patching tool enables a more streamlined and efficient process for creating multiple flavors of a binary module that can provide, for example, user experiences having different branding. As shown in FIG. 3, the resource patching tool 300 enables resources to be added or replaced into an existing binary module 302 post-build. In other words, the binary module can go through its normal development cycle but be compiled without any resources (or be compiled with resources that get replaced, or edited in some cases). Then, after it is built, the developer can go in and use the resource patching tool 300 to modify the binary module 302 with different sets of resources 305_{1, 2 . . . N} to implement the desired branding, such as GUIs 312_{1, 2 . . . N}, as shown, during execution. Use of the resource patching tool 300 therefore enables a single generic binary module to be built once and then have its multiple favors efficiently and quickly implemented by adding or replacing the appropriate resources 305.

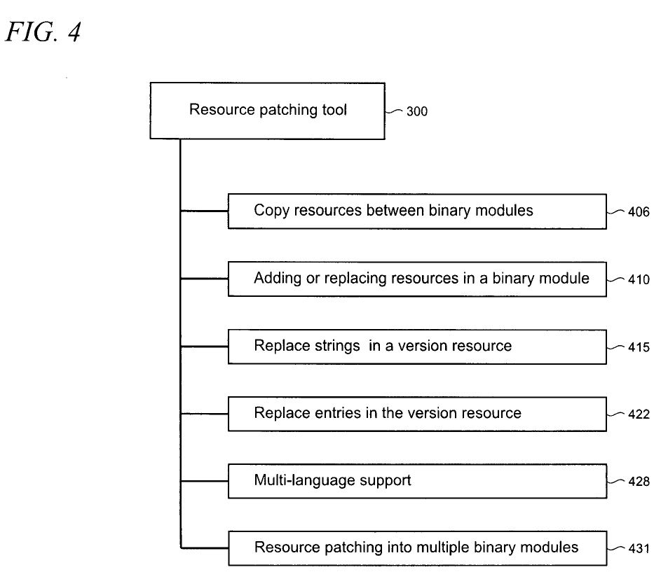

More specifically, as shown in FIG. 4, the resource patching tool 300 may be arranged to support a variety of features and functionalities. These include, for example, copying resources between binary modules (as indicated by reference numeral 406), adding or replacing resources in a binary module (410), replacing strings in a version resource (e.g., a file version or a program version) (415) such as changing “ABC Tech Co” to “ABC Technologies”, replacing entries in a version resource (422) such as the name of the publishing company, providing support for multiple languages (428), and patching the same set of resources into multiple binary modules (431). However, it is emphasized that these features and functionalities are merely illustrative. Not all such features and functionalities shown in FIG. 4 need to be supported in every implementation, and other features and functionalities may also be supported by the resource patching tool if needed.

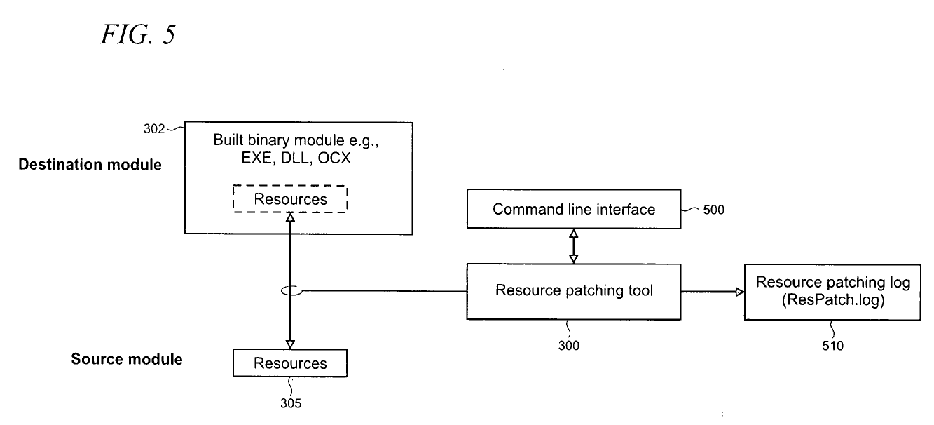

In one illustrative example, the resource patching tool 300 may be implemented using program code running on a computing platform such as a PC and that exposes a command line interface 500, as shown in FIG. 5. However, in other implementations, other types of user interfaces may also be employed such as GUIs and the like.

The command line interface 500 is configured to accept arguments as inputs in pairs—the first part of the pair specifying the role of the argument and the second part providing the argument's value. In some cases the value of the argument is a dummy value which means the content of the value is ignored even though its existence may be compulsory.

For purposes of the explanation of the command line arguments that follows, as shown in FIG. 5, the binary module 302 is referred to as the “destination module” and the resource file is referred to as the “source module.” The following illustrative command line arguments may be utilized by the present resource patching tool:
B—Save a backup for the destination module. By default there is no backup. (dummy value)
C—Codepage of the string in the version resource. A list of supported codepages is available at http//msdn.com if “Character Set Recognition” is input as a search. If the codepage has the letter A (e.g. 932A or 932a), the strings will be converted from ANSI character set an OEM character set (i.e., from Windows code page to DOS code page).
E—The source is an external file (supported resource types may include binary, manifest, and string).
   B—Binary or manifest support.
   S—String in the command line.
   I—String from an ini file. String size is limited to 1024 characters. The string is the data value of an ini key.
   Note: E can be a standalone parameter in which case it is used with a dummy value. (/e “dummy”).
S—Path to the key which data value is a String. Used combined with /ei.
F—Force operation on a folder tree without confirmation (see R below). (dummy value)
I or ID—Resource ID in the destination module. It can be an existing one, in which case the existing resource will be replaced, or a new one, so the new resource will be added.
IS—Resource ID in the source module.
K—Key in the version resource.
   If the key starts with “fixed:” (case insensitive) then it is a member of the fixed info structure. In that case the strings must contain numbers, decimal or hexadecimal (0x . . . ).
   After the word “fixed:” should be one of the VS_FIXEDFILEINFO member value names (e.g. fixed:dwFileVersionLS).
   Otherwise the key is one of the values displayed in the version info as an executable.
L—Language ID of the resource. Values should be numbers representing LANGIDs as appears at http://msdn.com
M or MD—Path to the destination module. If it only contains a name then the system searches in folders as specified in the documentation of LoadLibrary.
MS—Path to the source module. The comment pertaining to MD applies.
N—New String in the version resource, the one that should be inserted into the destination module.
O—Old String in the version resource, the one that should be deleted from in the destination module.
R—Root folder when resource patching should apply to the contents of a folder tree.
   In this case the destination module should be a masked file name (e.g. *.dll or ?Agent.exe).
   Note: If there is no root folder and the destination module is a mask the folder where ResPatch resides is the root folder.
   Unless /f is specified a message box confirming the operation.
T—Resource Type*. Can be a numbers or strings according to the documentation of the function FindResource.
V—Version and then the 4 integers (<65536) separated by dots representing the new version: #.#.#.#.
Will replace File Version and Product Version.
VF—Like V, for replacing File Version only.
VP—Like V, for replacing Product Version only.
FC—Final Check: tries to load the patched resource and verifies it was patched correctly. Also pops up a message box on failure.
   * note that Resource Types may be located at http://msdn2.microsoft.com/en-us/library/ms648009.aspx

| Value | Num |
|---|---|
| RT_ACCELERATOR | 9 |
| RT_ANICURSOR | 21 |
| RT_ANIICON | 22 |
| RT_BITMAP | 2 |
| RT_CURSOR | 1 |
| RT_DIALOG | 5 |
| RT_DLGINCLUDE | 17 |
| RT_FONT | 8 |
| RT_FONTDIR | 7 |
| RT_GROUP_CURSOR | 12 |
| RT_HTML | 23 |
| RT_ICON | 3 |
| RT_MANIFEST | 24 |
| RT_MENU | 4 |
| RT_MESSAGETABLE | 11 |
| RT_PLUGPLAY | 19 |
| RT_RCDATA | 10 |
| RT_STRING | 6 |
| RT_VERSION | 16 |
| RT_VXD | 20 |

When editing version resources, the following arguments are relevant:
Destination Module (md), New String (n), Old String (o), Key (k), Language (l), Codepage (c), Backup (b).
For replacing strings within the version resource regardless of key. The replaced string can be a substring of a key (e.g. replacing GTAgent with PCPal where the resource is GTAgent Browser will output PCPal Browser.
The following arguments are mandatory:
   Destination module (md).
   New string (n).
   Old string (o).
For editing entries within the version resource the following arguments are mandatory:
   Destination module (md).
   New string (n).
   Key (k).
Optional:
   Backup (b).
   Language (l). Use it if the version resource is not English.
   Codepage (c). Use it if the strings within the English version resource are not English.

For replacing resources the following arguments are relevant:
Mandatory:
   Destination module (md). Copying into it.
   Source module (md). Copying from it.
   Resource type (t).
   Resource ID in the destination module (id).
   Resource ID in the source module (is).
Optional
   Backup (b).
   Language (l). Use it if the resource is not English.

Also shown in FIG. 5 is a resource patching log 510 (named ResPatch.log) that is created by the resource patching tool 300. The resource patching log is used to indicate whether resource patching is successful. The ResPatch.log file will typically be located in a temporary directory.

Several illustrative examples of input to the command line interface 500 now follow. Note that argument values that contain spaces are framed with quotation marks. In addition, argument roles should have ‘-’ or ‘/’ as their first character.
Replacing/adding an icon.
We copy icon 165 from AURsrc.dll as 200 in AuAgent.exe.
Note the quotation marks.
   respatch /md s:\AuAgent.exe/ms “s:\My Folder\AURsrc.dll” /t 14 /id 201 /is 165
Replacing/adding a Japanese menu and saving backup of the original file:
   respatch /md AUBrowse.exe /ms “AURsrc.dll” /t 4 /id 200 /is 163 /l 1041 /b
   respatch /md AUBrowse.exe /ms “AURsrc.dll” /b “dummy” /t 4 /id 200 /is 163 /l 1041
Replacing an English string with a Japanese one in an English version resource in a folder tree (without confirmation):
   respatch /f “true” /r s:\test /md *.exe /o GTAgent /n “Canon POP [symbol] /c 932
Replacing a version of a file (both product version and file version).
This is potentially tricky because there are 4 fixed values that contain the versions and 2 strings so we might need 6 calls.
Here we change the file and product version of qdiagd.ocx from 1.0.1.424 to 1.0.1.422.
Note: we need to change 2 fixed values because the high version numbers are left “1.0”.
   respatch /m qdiagd.ocx /k fixed:FileVersionLS /o 0x101a8 /n 0x101a6
   respatch /m qdiagd.ocx /k FileVersion /o “1, 0, 1, 424” /n “1, 0, 1, 422”
   respatch /m qdiagd.ocx /k fixed:ProductVersionLS /o 0x101a8 /n 0x101a6
   respatch /m qdiagd.ocx /k ProductVersion /o “1, 0, 1, 424” /n “1, 0, 1, 422
Adding a String from an external resource.
   respatch /md s:\GTAAgnt.exe /es “Canon POP” /id 555
   respatch /md s:\GTAAgnt.exe /ei “C:\res.ini” /s section1\Key1 /id 544
   respatch /md s:\GTAAgnt.exe /eb noelevation.manifest /t “RT_MANIFEST” /id 1
   respatch /md s:\GTAAgnt.exe /ms noelevation.manifest /e “false” /t “RT_MANIFEST” /id 1
   respatch /md s:\GTAAgnt.exe /ms noelevation.manifest /t “RT_MANIFEST” /id 1 /e
Adding a user defined passing the resource as a string.
   respatch /md s:\GTAAgnt.exe /t USERT /es “00 04 00 56 22 00” /id 501
Replacing version (all, file only, product only):
   respatch /md s:\GTAAgnt.exe /v “1.0.0.53”
   respatch /md s:\GTAAgnt.exe /vf “1.1.0.53”
   respatch /md s:\GTAAgnt.exe /vp “1.2.0.53”

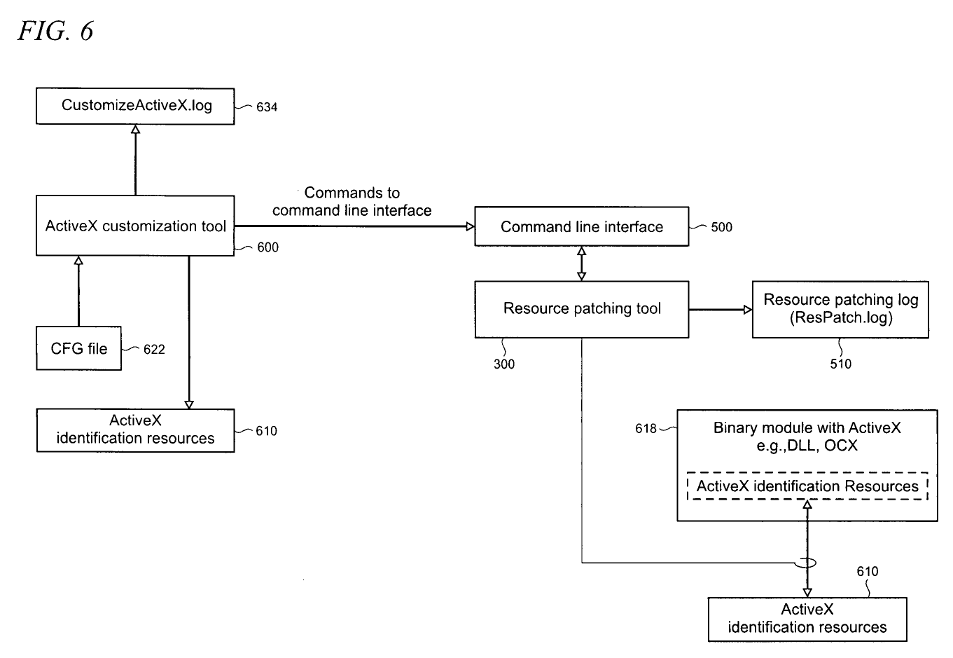

FIG. 6 shows the interoperation of an ActiveX customization tool 600 and the resource patching tool 300 to enable substitute ActiveX identification resources 610 to be generated and then patched into a binary module with ActiveX controls 618 such as a DLL or OCX. The substitute ActiveX identification resources 610 will typically comprise CLSIDs (Class identifiers) and ProgIDs (program identifiers) which are contained within the RGS resources (i.e., registry script) that specify the registry settings for the ActiveX control including the registry keys and values that are added/removed when an ActiveX control is registered/unregistered. Similarly, the ActiveX customization tool 600 will replace necessary data within the TLB (Typelib) resources from the IDL (interface definition language) file.

The substitute RGS file and TLB file (which comprises compiled IDL files if the original IDL files have been recently changed) which form the substitute ActiveX identification resources 610 will get patched (i.e., injected) into the binary module 618 by the resource patching tool 300 via commands received at the command line interface 500. The commands are embedded in a detailed CFG (configuration) file 622 that specifies how the ActiveX customization tool should operate and the location of the relevant resources. In particular, the CFG file 622 defines what the ActiveX customization tool 600 gets as an input and what it produces as an output. Illustrative input and output specifications are shown below. Note that required sections are indicated in boldface and further that section and parameter names are case sensitive.
[CLSID]
   [Input]—Numbered parameters containing the original CLSIDs without braces. The numbers indicate the resource numbers expected by the module.
   [Output]—This section will be created upon first use of the CFG. It contains the substitutive CLSIDs, generated if not previously defined.
[Text]—This section is optional, but if you have it, you need its subsections.
   [Input]—Strings to be replaced in the RGS & IDL files. Typically will include the ProgId and module name. Parameter names do not matter as the whole section is enumerated.
   [Output]—Strings to be injected. Parameters names should correspond to those in [Input].
[RGS]
   [Input]—Numbered parameters containing the path to the original RGS files. The paths can be absolute or relative to the CFG. The numbers indicate the resource numbers of the RGS file in the original module.
   [Output]—This section contains paths to the RGS created after replacing the strings in them. The files will be created upon first use. The folder where they reside must exist.
   [TimeStamp]—Contains time stamps of the original RGS files. Each time they are reviewed, their time stamps are compared to those in the CFG, if they exist and only if the original file was changed after the last customization, a new patched RGS is created.
   The format is a QWORD equivalent to Windows' FILETIME (more information is available at http://msdn.com).
[TLB]
   [Input]—Numbered parameters containing the path to the original IDL files. The paths can be absolute or relative to the CFG. The numbers indicate the resource numbers of the TLB resource generated by the IDL compiler in the original module.
   [Output]—This section contains paths to the TLB created after replacing the strings in them. The files will be created upon first use. The folder where they reside must exist.
   A temporary IDL file is created and deleted by default after used to generate a patched TLB.
      DeleteTempFiles—If this parameter equals 0 the temporary IDL and the files the IDL compiler generates are not deleted.
   [Compiler]
      CommandLine—Command line parameters for MIDL, the IDL compiler.
   [TimeStamp]—Contains time stamps of the original IDL files. Each time they are reviewed, their time stamps are compared to those in the CFG, if they exist and only if the original file was changed after the last customization, a new patched TLB is created.
   The format is a QWORD equivalent to Windows' FILETIME (more information is available at http://msdn.com).
[Patch]
   DirRelativeToResPatch—This parameter specifies the relativity between the TLB and RGS files and ResPatch.exe. Used to generate correct command line parameters for ResPatch.exe.
   Note that it means all RGS and TLB files must be directed to the same folder.
   The other parameters are generated automatically according to the patching done previously.
   Parameter names are usually TYPE###, the resource type and number, for instance CLSID200, RGS102, or TLB1.
   These values are destined for a Custom Build CFG file used by a Custom Build PLIS script.

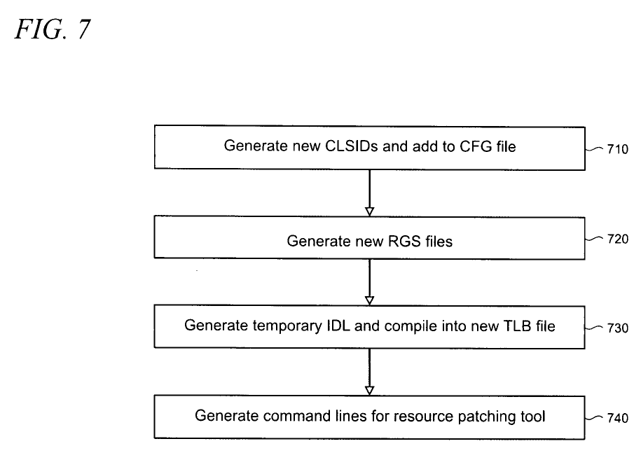

When the ActiveX customization tool 600 is run, it will write to a log 634 (named “CustomizeActiveX.log” in this example) to indicate success or failure of its operations. FIG. 7 shows an illustrative flowchart of operations of the ActiveX customization tool.

The ActiveX customization tool will generate new CLSIDs and add them to the CFG file 622 (as indicated by reference numeral 710). New RGS files are then generated to replace the CLSIDs and text (720). A temporary IDL will be compiled into a new TLB (730). Appropriate commands for input to the resource patching tool are then created so that the newly created substitute ActiveX identification resources are patched into the binary module 618 (740) to thus generate the desired branding.

An illustrative CFG prior to the ActiveX customization tool 600 being run is provided below:

```
[CLSID]
  [Input]
    200=D4F6838E-B8E1-43DB-995D-9282551F505C
    201=B68AD43B-E445-465C-8B05-AB0AC89F09BF
    202=E091D93D-E2CE-40A1-8CB4-97A0F8B8ED0B
    203=82CA137B-5146-40FC-BD23-946B7BAF2A23
  [ ]
[ ]
[Text]
  [Input]
    Name=GTSite
  [ ]
  [Output]
    Name=GTWebCheck
  [ ]
[ ]
[RGS]
  [Input]
    101=Z:\GTSite\Public\lib\GTSite\GTSite\GTSite.rgs
    103=Z:\GTSite\Public\lib\GTSite\GTSite\GTSiteCtl.rgs
  [ ]
  [Output]
    101=GTWebCheck.rgs
    103=GTWebCheckCtl.rgs
  [ ]
[ ]
[TLB]
  [Input]
    1=..\..\..\..\..\..\Public\lib\GTSite\GTSite\GTSite.idl
  [ ]
  [Output]
    1=GTWebCheck.tlb
  [ ]
  [Compiler]
    CommandLine=/D “NDEBUG” /nologo /char signed /env win32 /
Oicf/no_robust
  [ ]
[ ]
[Patch]
  DirRelativeToResPatch=res
  [ ]
```

The CFG file after being modified by the operation of the ActiveX customization tool 600 is shown below:

```
[CLSID]
  [Input]
    200=D4F6838E-B8E1-43DB-995D-9282551F505C
    201=B68AD43B-E445-465C-8B05-AB0AC89F09BF
    202=E091D93D-E2CE-40A1-8CB4-97A0F8B8ED0B
    203=82CA137B-5146-40FC-BD23-946B7BAF2A23
  [ ]
  [Output]
    200=09226C7E-FF8C-476F-99BD-8A1DAD6CB9C3
    201=758F1497-72C7-430F-A9D0-7ADE468DB9CE
    202=80C02E7B-5FAF-4BB5-9B39-15A16AF772AE
    203=54993920-F5CB-4D04-A810-B85576F36D60
  [ ]
[ ]
[Text]
  [Input]
    Name=GTSite
  [ ]
  [Output]
    Name=GTWebCheck
  [ ]
[ ]
[RGS]
  [Input]
    101=Z:\GTSite\Public\lib\GTSite\GTSite\GTSite.rgs
    103=Z:\GTSite\Public\lib\GTSite\GTSite\GTSiteCtl.rgs
  [ ]
  [Output]
    101=GTWebCheck.rgs
    103=GTWebCheckCtl.rgs
  [ ]
  [TimeStamp]
    101=127978507580000000
    103=127978507920000000
  [ ]
[ ]
[TLB]
  [Input]
    1=..\..\..\..\..\..\Public\lib\GTSite\GTSite\GTSite.idl
  [ ]
  [Output]
    1=GTWebCheck.tlb
  [ ]
  [Compiler]
    CommandLine=/D “NDEBUG” /nologo /char signed /env win32 /
Oicf/no_robust
  [ ]
  [TimeStamp]
    1=127978507590000000
  [ ]
[ ]
[Patch]
  DirRelativeToResPatch=res
  CLSID200=/id 200 /es 09226C7E-FF8C-476F-99BD-8A1DAD6CB9C3
  CLSID201=/id 201 /es 758F1497-72C7-430F-A9D0-7ADE468DB9CE
  CLSID202=/id 202 /es 80C02E7B-5FAF-4BB5-9B39-15A16AF772AE
  CLSID203=/id 203 /es 54993920-F5CB-4D04-A810-B85576F36D60
  RGS101=/t REGISTRY /id 101 /eb “res\GTWebCheck.rgs”
  RGS103=/t REGISTRY /id 103 /eb “res\GTWebCheckGTSiteCtl.rgs”
  TLB1=/t TYPELIB /id 1 /eb “res\GTWebCheck.tlb”
[ ]
```

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, perform a method for patching ActiveX identification resources into a binary module, the method comprising the steps of:
finding ActiveX identification resources in a binary module;
generating substitute ActiveX identification resources; and
patching the substitute ActiveX identification resources into the binary module to generate a binary module having ActiveX branding that is implemented according to the patched ActiveX identification resource.

2. The computer-readable medium of claim 1 in which substitute ActiveX identification resources comprise ActiveX registration data.

3. The computer-readable medium of claim 2 including a further step of generating patching commands.

4. The computer-readable medium of claim 3 in which the patching commands are written to a configuration file, the configuration file further specifying a location for the substitute ActiveX identification resources.

5. The computer-readable medium of claim 4 including a further step of patching different ActiveX identification resources into a generic binary module in order to concurrently run multiple similar ActiveX controls but which are registered as distinctly different objects.

6. The computer-readable medium of claim 1 including a further step of generating an ActiveX customization log file.

7. The computer-readable medium of claim 1 in which the binary module is an executable file.

8. The computer-readable medium of claim 7 in which the binary module is one of DLL, or OCX.

9. A method for generating a binary module, the method comprising the steps of:
building a generic binary module;
patching a first set of ActiveX resources into the generic binary module; and
repeating the patching with a second set of ActiveX identification resources to generate different ActiveX identities for the generic binary module that may be individually registered and, when executed, each implementing an ActiveX control having different branding.

10. The method of claim 9 in which the patching is performed using a resource patching tool.

11. The method of claim 10 in which the resource patching tool receives command lines that are embedded in a configuration file.

12. The method of claim 11 in which the command line interface processes arguments in pairs, a first element in a pair specifying a role of the argument and a second element in the pair specifying a value.

13. The method of claim 12 in which the value is a dummy value.

14. The method of claim 9 in which the individual registration enables concurrent execution of binary modules using ActiveX controls having different branding.

15. The method of claim 9 in which the different branding varies by one of icon, menu, dialog box, bitmap, or string.

16. A computer-readable medium containing instructions which, when executed by one or more processors disposed in an electronic device, implement a binary module that is arranged for performing a method comprising the steps of:
implementing a functionality that utilizes branding, the branding being realized through ActiveX controls that are identified using a set of ActiveX identification resources that is incorporated into the binary module; and
accepting changes to the set of ActiveX identification resources so that the multiple brands of ActiveX may be concurrently run without interdependency.

17. The computer-readable medium of claim 16 in which the accepting is performed in part through use of an ActiveX customization tool that enables the ActiveX identification resources to be located and modified.

18. The computer-readable medium of claim 16 in which the functionality is implemented using a generic binary module, the functionality being unaffected by changes to the set of ActiveX identification resources.

19. The computer-readable medium of claim 16 in which the changes to the set of resources are made using a resource patching tool.

20. The computer-readable medium of claim 16 in which the ActiveX identification resources comprise registry keys and associated values.
